(19) United States
(12) Patent Application Publication
(10) Pub. No.: US 2011/0070988 A1
(43) Pub. Date: Mar. 24, 2011

(54) STEEL ROPE CHAIN FOR POWER TRANSMISSION

(76) Inventor: KUO-SHEN LIU, Taipei (TW)

(21) Appl. No.: 12/564,060

(22) Filed: Sep. 22, 2009

(51) Int. Cl. F16G 1/22

(52) U.S. Cl. 474/204

(57) ABSTRACT

A steel rope chain is provided for power transmission, including a plurality of parallel and juxtaposing closed steel ropes to which a plurality of equally-spaced wire rope clips is mounted. The wire rope clips are arranged in a juxtaposed manner and fixed to an elongate thick steel plate to form an array of clip assemblies that secure the steel ropes together. Mating the steel rope chain are a driving wheel and a driven wheel that are selectively made in various forms provided they include spokes having free ends carrying crossbars so that when the driving wheel rotates, the crossbars of the driving wheel are brought into engagement with the clip assemblies to drive movement of the steel rope chain and the steel rope chain in movement brings the clip assemblies into engagement with the crossbars of the driven wheel to cause rotation of the driven wheel.

### (a) TECHNICAL FIELD OF THE INVENTION

The present invention generally relates to a steel rope chain for power transmission, and more particularly to a large-sized power transmission device that is not limited in the power transmitted thereby, is easy to manufacture, and uses less materials, so as to make the manufacturing thereof low cost and the maintenance easy.

### (b) DESCRIPTION OF THE PRIOR ART

Mechanical arrangements for power transmission are generally classified in the following four types, all of which are subjected to a limit of the power transmitted thereby and also have the following list of disadvantages:

(1) Gear, which has the disadvantages of (a) requiring high precision of manufacturing, (b) requiring high strength materials, (c) being hard to manufacture large-sized gears, which is time- and labor-consuming and increases the cost, (d) not tolerating vibration, (e) noise induced in the operation thereof, (1) requiring frequent lubrication and timed maintenance, leading to increase of maintenance cost, and (g) susceptible to corrosion caused by water and dust.

(2) Chain sprocket, which has the disadvantages of (a) requiring frequent lubrication and maintenance, leading to increase of maintenance cost, (b) incapable of high speed operation, (c) susceptible to undesired extension of the chain caused by fatigue after long term operation, (d) not tolerating severe vibration, and (e) susceptible to corrosion caused by water and dust.

(3) V-shaped belt pulley, which has the advantages of (a) incapable to ensure synchronous rotation of two wheels, (b) lower efficiency of transmission, (c) limited magnitude of tension transmitted thereby, and (d) susceptible to corrosion caused by heat, sun radiation, water, grease, and dust.

(4) Timing belt, which has the disadvantages of (a) limited magnitude of tension transmitted thereby, and (b) susceptible to corrosion caused by heat, sun radiation, water, grease, and dust.

Thus, all the power transmission devices that are currently available can not completely overcome the above problems. In view of this, the present invention aims to provide a power transmission steel rope chain that overcomes the problems of the conventional power transmission structures.

### SUMMARY OF THE INVENTION

A primary objective of the present invention is to provide a steel rope chain for power transmission in order to overcome the limitation imposed to the amount of power transmitted by a large-sized power transmission device and featuring simple manufacturing, reduced material used, low manufacturing cost, and easy maintenance.

The power transmission steel rope chain of the present invention comprises a plurality of parallel and juxtaposing closed steel ropes to which a plurality of equally-spaced wire rope clips is mounted. The wire rope clips are arranged in a juxtaposed manner and fixed to an elongate thick steel plate to form an array of clip assemblies that secure the steel ropes together. Mating the steel rope chain are a driving wheel and a driven wheel that are selectively made in various forms provided they include spokes having free ends carrying crossbars so that when the driving wheel rotates, the crossbars of the driving wheel are brought into engagement with the clip assemblies to drive movement of the steel rope chain and the steel rope chain in movement brings the clip assemblies into engagement with the crossbars of the driven wheel to cause rotation of the driven wheel, thereby realizing power transmission.

In accordance with the power transmission steel rope chain of the present invention, the diameter and number of the steel ropes used are determined according to power transmitted thereby. The joint of two ends of each steel rope is realized by sideways mounting a wire rope clip to the jointed ends to have them fixed together to make the steel rope closed.

In accordance with the power transmission steel rope chain of the present invention, the distance between adjacent wire rope clips is substantially corresponding to the distance between adjacent crossbars of the minor wheel. The distance between adjacent crossbars of the major wheel is an integer multiple of the distance between the crossbars of the minor wheel.

In accordance with the power transmission steel rope chain of the present invention, one or more idle rollers are arranged between the two wheels to hold down the steel ropes and thus keep the steel rope chain in stable engagement with the crossbars.

Due to manufacturing error or tolerance occurring in the distance between the wire rope clips and the crossbars and also due to thermal expansion caused by temperature difference resulting from weather changes, and also due to undesired extension of the steel ropes caused by long use, the power transmission steel rope chain as described above can be further incorporated with an automatic adjustment mechanism to automatically adjust the distance of the wire rope clips so as to ensure the engageability between the wire rope clips and the crossbars even under the above described adverse conditions.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the structure of a middle section of a steel rope chain in accordance with the present invention.

FIG. 2 shows the structure of a joint section of the steel rope chain of the present invention.

FIG. 3 shows the whole structure of the steel rope chain and hubs and spokes of the present invention.

FIG. 4 shows contact engagement formed between the steel rope chain and crossbars.

FIG. 5 shows the structure of a hub interposed plate in accordance with the present invention.

FIG. 6 shows an example of automatic adjustment mechanism in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

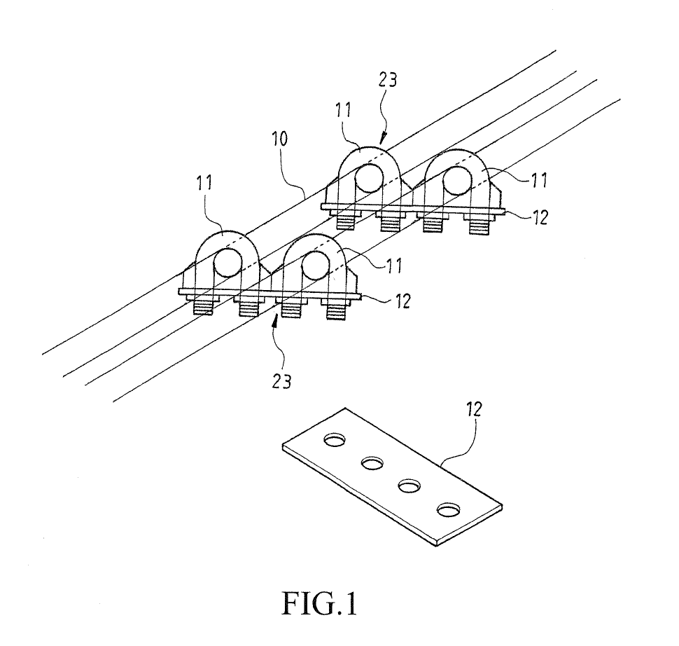

Referring to FIG. 1, a steel rope chain constructed in accordance with the present invention is shown. As shown, the present invention mainly comprises a plurality of parallel and juxtaposing steel ropes 10. Wire rope clips 11 are fastened to the steel ropes. An elongate thick steel plate 12 (a perspective view of the elongate thick steel plate 12 being shown in the lower portion of the drawing) is connected between the wire rope clips 11 so as to fix two wire rope clips 11 together as a clip assembly 23, which secures two parallel steel ropes 10 together. The distance between adjacent clip assemblies in the lengthwise direction is preferably fixed. Alternatively, the wire rope clip 11 can be manufactured in such a way that multiple wire rope clips 11 are integrated together in the casting operation thereof so that the elongate thick steel plate 12 can be omitted.

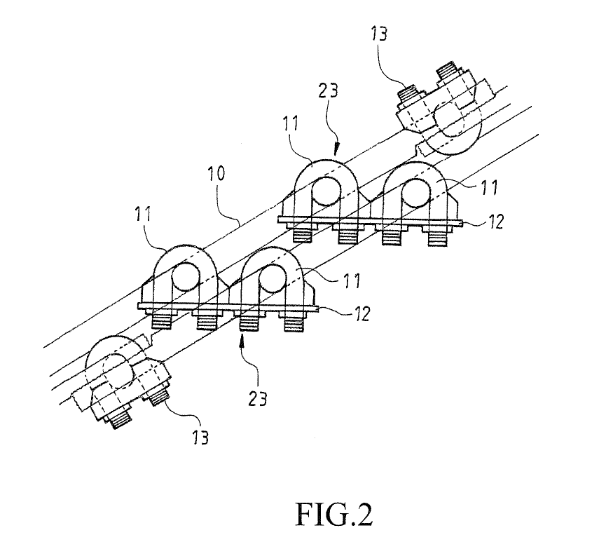

The steel rope 10 must be set in a closed form. As shown in FIG. 2, a joint connecting opposite ends of the steel rope 10 is formed by a wire rope clip 13 sideways mounted thereto. If the steel rope is to subject to a great tension, then each steel rope 10 can be jointed by multiple wire rope clips 13 that are mounted to the steel rope.

In FIGS. 1 and 2, which are mentioned above, only two steel ropes 10 are shown. In practical applications, the diameter and the number of the steel ropes 10 are determined according to the magnitude of the tension to be applied thereto.

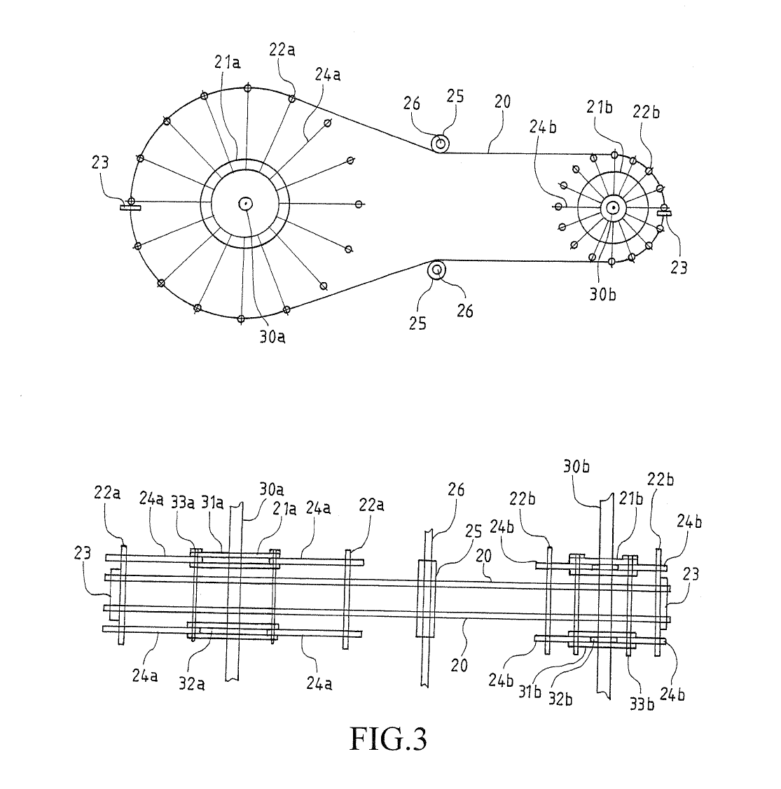

Referring to FIG. 3, a schematic view illustrating the steel rope chain and a driving wheel and a driven wheel mating the steel rope chain is given. The wheels can be of any desired configuration, provided each spoke of each wheel has a free end that carries and supports a crossbar. An example will be given herein for explanation purposes. As shown in the drawing, the upper portion of the drawing shows a front view, while the lower portion is a top plan view. The steel rope chain 20 of the present invention is operated with a major wheel (driven wheel) and a minor wheel (driving wheel). Both the major and minor wheels have a hub 21a, 21b and spokes 24a, 24b. Each spoke 24a, 24b has a distal free end to which a crossbar 22a, 22b is mounted. In the instant embodiment, the hub 21a, 21b has two sides. The hub 21a is composed of two outside wheel members 31a and an intermediate interposed plate 32a, which are fixed by a plurality of bolts 33a. Similarly, the hub 21b is composed of two outside wheel members 31b and an intermediate interposed plate 32b, which are fixed by a plurality of bolts 33b. Arranged between the two wheels is one or more idle roller 25 for holding down the steel rope chain 20 so as to keep the steel rope chain 20 in stable and maintained engagement with the crossbars 22a, 22b. The idle rollers 25 are supported and retained by idle roller shafts 26. The hubs 21a, 21b are respectively provided with hub shafts 30a, 30b.

In the embodiment, the spokes 24a are arranged at two sides and the number of the spokes 24a is determined according to amount of power transmitted. As shown in the drawing, each side comprises 16 spokes and there are totally 32 spokes in two sides. This also applies to the spokes 24b. Thus, the number of the crossbars 22a or 22b is 16. The distance between adjacent crossbars 22b of the minor wheel is substantially corresponding to the distance between adjacent wire rope clips, and the distance between adjacent crossbars 22a of the major wheel is an integer multiple of the distance between the wire rope clips.

In this drawing, only two clip assemblies 23 are shown as representative examples and in an actual application, the whole length of the steel rope chain 20 is provided with multiple equally spaced clip assemblies 23.

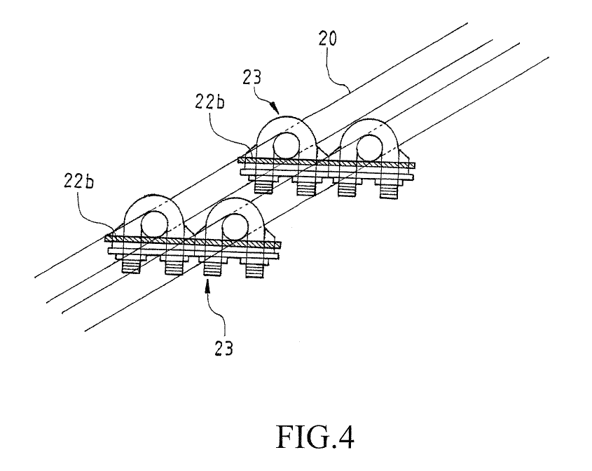

Referring to FIG. 4, in the operation of the present invention, with the hatched members indicating the crossbars 22b, when the driving wheel (the minor wheel) rotates, the crossbars 22b are brought into driving engagement with the clip assemblies 23 to drive a movement of the steel rope chain 20. When the steel rope chain is in movement, the clip assemblies 23 are brought into driving engagement with the crossbars 22a of the driven wheel (the major wheel) to cause the rotation of the driven wheel, thereby transmitting power from the driving wheel to the driven wheel. It is preferable that during the operation, the steel rope chain 20 is in a circular form.

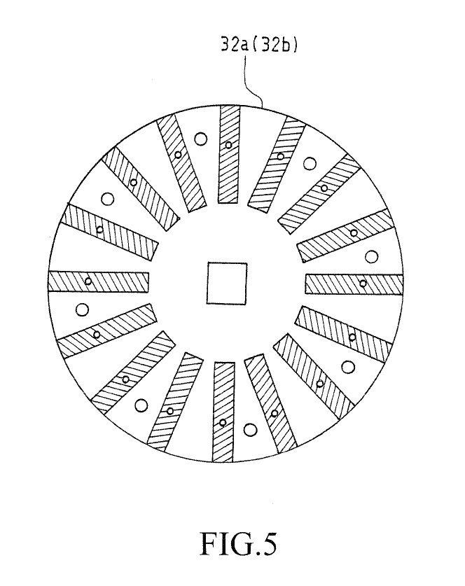

Referring to FIG. 5, the interposed plate 32a, 32b of the hubs will be described in more details. The hub interposed plate 32a, 32b is made in the form of a circular disk having a thickness corresponding to the spoke 24a or the spoke 24b. In the drawing, the hatched portions are removed from the interposed plate 32a, 32b to accommodate the spoke 24a, 24b. The opposite surfaces of the interposed plate 32a, 32b are then tightly fixed to the outside wheel members 31a, 31b by bolts 33a, 33b to thereby secure the spokes 24a, 24b.

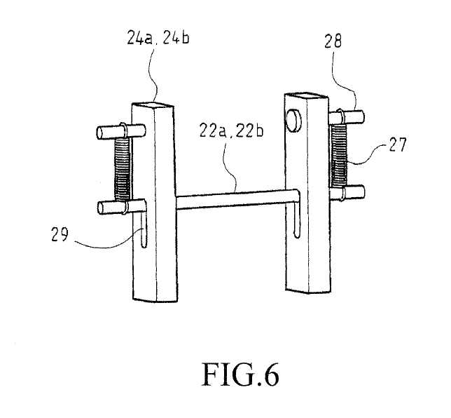

Referring to FIG. 6, an automatic adjustment mechanism may be included and a description will be given as follows. As shown, the crossbars 22a, 22b are not fixedly mounted to the spokes 24a, 24b, and instead, each crossbar 22a, 22b is supported, in a suspended manner, by two springs 27 on two spring mounting studs 28. The spokes 24a, 24b define aligned elongate slots 29 through which the crossbar 22a, 22b extends so that the crossbar 22a, 22b is allowed to move along the slots to correspond to the variation in distance of the wire rope clips thereby automatically adjusting the distance of the crossbars to ensure the engageability of the crossbars with the wire rope clips. Thus, the crossbars 22a, 22b can surely engage the wire rope clips even there is any error or tolerance caused by human error or other factors.

According to the above description, the power transmission steel rope chain of the present invention operates in a way similar to a sprocket chain. However, in the transmission operation, the teeth of the sprocket are fit into the cavities of a sprocket chain to realize the power transmission. The steel rope chain of the present invention uses the wire rope clips mounted thereto and projecting therefrom the engage the crossbars of a wheel so as to realize power transmission. The configurations between the two are totally different.

It is noted that the power transmission steel rope chain of the present invention is formed by steel ropes to which clip assemblies are fixed to mate a driving wheel and a driven wheel so that the power applied to any large-sized power transmission facilities is not subjected to any limitation. Further, the steel rope chain of the present invention is resistant to sun radiation and rains, is not affected by vibration, and is capable of synchronized operation, so that all the drawbacks found in the prior art technologies can be overcome. Further, the manufacturing of the steel rope chain is easy, the material used in the manufacturing is less, and thus the manufacturing cost is low and the maintenance is easy.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power transmission steel rope chain comprising a plurality of parallel and juxtaposing closed steel ropes to which a plurality of equally-spaced wire rope clips is mounted, the wire rope clips being arranged in a juxtaposed manner and fixed to an elongate thick steel plate to form an array of clip assemblies that secure the steel ropes together; and a driving wheel and a driven wheel that selectively mate the wire rope clips to realize transmission of power.

2. The power transmission steel rope chain according to claim 1, wherein the driving wheel and the driven wheel that mate the steel rope chain are selectively made in various forms and comprise spokes having distal free ends that carry crossbars or steel ropes so that when the driving wheel rotates, the crossbars of the driving wheel are brought into engagement with the clip assemblies to drive movement of the steel rope chain and the steel rope chain in movement brings the clip assemblies into engagement with the crossbars of the driven wheel to cause rotation of the driven wheel.

3. The power transmission steel rope chain according to claim 1, wherein the wire rope clips are selectively made in various forms and are selectively made by casting the integrate together in a juxtaposed arrangement so as to omit the elongate thick steel plate.

4. The power transmission steel rope chain according to claim 1, wherein two ends of each steel rope are jointed to each other and are fixed together by a wire rope clip sideways mounted thereto to make the steel rope closed.

5. The power transmission steel rope chain according to claim 1, wherein the steel ropes of the steel rope chain have a diameter and number determined according to power transmitted thereby.

6. The power transmission steel rope chain according to claim 2, wherein idle roller is arranged between the wheels to keep the clip assemblies in stable engagement with the crossbars.

7. The power transmission steel rope chain according to claim 2, further comprising an automatic adjustment mechanism that ensures the engageability between the wire rope clips and the crossbars even though an error caused by various factors exists.
